(19) United States
(12) Patent Application Publication
(10) Pub. No.: US 2017/0017801 A1
(43) Pub. Date: Jan. 19, 2017

(54) MEANS FOR MANAGING RIGHTS TO FOLLOW FOR DIGITAL OBJECTS

(71) Applicant: Alain ROSSET, Lyon (FR)

(72) Inventor: Alain ROSSET, Lyon (FR)

(21) Appl. No.: 15/125,096

(22) PCT Filed: Mar. 10, 2015
(86) PCT No.: PCT/FR2015/050585

§ 371 Date: Sep. 9, 2016

(30) Foreign Application Priority Data
Mar. 10, 2014 (FR) 14/51928

(51) Int. Cl. G06F 21/62; H04L 29/06

(52) U.S. Cl. CPC G06F 21/6245; H04L 63/101

(57) ABSTRACT

Means for managing resale rights for digital objects. The invention relates to a method for managing usage rights, granted to users by a supplier, for a first version of a digital object, comprising the following steps: (a) providing a user with a second version of the digital object, derived from the first version; (b) receiving a request to use at least one subset, however small, of the first version of the digital object, comprising a usage code; (c) checking the validity of the usage code; (d) in case the usage code is assessed to be valid, transmitting decoding information to the user required to reconstitute, from the second version of the digital object, said subset of the first version; (e) updating at least one usage code validity repository.

### TECHNICAL FIELD

The present invention relates to the field of the online, secure distribution, monetization, reading and/or execution of digital objects, on the communication networks such as Internet. It concerns more particularly systems enabling any cybernaut to purchase and resell uses of digital objects, while preserving the privacy of the personal data or even to guarantee the anonymity, as well as to preserve the market value of said digital objects and the copyrights of the digital object.

### BACKGROUND

On the communication networks such as Internet, the users can easily provide a wide variety of digital objects. Digital objects means in particular images, documents such as books, video and/or audio recordings, computer applications such as video games, or even any form of transferable information on the communications networks. This option of sharing has quickly highlighted a need for rights to use management means, in particular to ensure the compliance with the intellectual property rights relating thereto and other rules governing the dissemination and the use of said objects. However, providing means adapted to allow the compliance with these laws and regulations, the control of their uses, their copies of their sales or rentals, and even preserving their market value, has proved to be problematic.

Digital Rights management systems, commonly known by the acronym <<DRM>> have been developed, typically using technical means of protection to prevent unauthorized copying and use thereof. These systems are, in particular, implemented by online services or marketplaces, generally using an application layer above the communication networks such as Internet. These solutions use cryptographic techniques of content or communication channels carrying said content. Such solutions are expensive to be set up and exploited, uncomfortable and restrictive for most users, and aim to limit the dissemination of content. More particularly, these infrastructures require complex management of license certificates, private and public keys, and encrypted files, and typically involve identifying the material device(s) on which the digital object purchased uses will be performed. Furthermore, these systems are ill-suited for the management of the rights of the providers during the use resale or lending by the users themselves: indeed, besides the aforementioned problems, the rights digital management systems typically handles the problem of use resale or lending by prohibiting the copies, thereby limiting the dissemination, including the dissemination on a plurality of electronic devices belonging to the environment of a same user.

That is why there is a need to allow a simple and effective management of rights to use of digital objects on communication networks such as Internet. In particular, there is a need for means adapted to the management of the rights of the providers during the resale of uses by the users themselves.

### BRIEF SUMMARY

The disclosure provides simple and effective management means of rights to use of digital objects on communication networks such as Internet. Digital objects means, in particular, images, documents such as books, video and/or audio recordings, computer applications such as video games or interactive simulation tools, or even any form of transferable information on the communication networks. The invention furhter provides means adapted for the providers rights management during the uses resale or lending by the users themselves. The invention allows the digital objects provider to manage rights to use of said objects throughout their life cycle and/or their dissemination, in particular to control and/or modify at any time the conditions and constraints that he wishes to impose. The invention allows the different stakeholders to obtain information feedback about the uses of the digital objects. The invention provides a simple and economical solution, enabling the provider to control the uses of his contents and enabling him to authorize any person to sell or lend the uses under his control, and possibly by rewarding them financially, but not limited to, in exchange for of assets of any kind, including discounts on future purchases. The invention provides users who have obtained rights to use one or more digital objects with the possibility to keep their anonymity as well as that of their electronic devices.

The disclosure further provides means to securely monetize online uses of digital objects on the communication networks or on hardware media, under the permanent control of their provider. The invention provides means for authorizing any user of one of the communication networks or hardware medium to resell himself the uses of digital objects of a provider without departing from its imposed use constraints and conditions. The invention provides means to remunerate said resellers, including bonuses possibly provided by the latter, such as, but not limited to, new subtitling or dubbing, a compilation of extracts. The invention allows the partial or total copy of a digital object processed by a technique of the invention on any physical or virtual storage device (local or remote respectively), through a communication protocol such as, but not limited to, TCP, FTP, UDP, P2P, WEBRTC, P2PTV, HTTP, HSL, without modifying the modalities of use of a digital object by a user of one of the communication networks.

The invention aims, in particular to provide solutions for the consumers of digital object, on communication networks, in particular, but not exclusively, those who purchase on the recommendation of third-party, or those who purchase as much as they can resell digital objects via the communication networks. The invention allows, in particular, preserving the anonymity of the consumers and the resellers. The invention further allows keeping the events and the behavioral actions of the consumers and allows optionally setting up a safe watermarking in order to identify any illicit sharing attempt obtained from screenshots or the output of a video card from a computer, in particular.

More particularly, according to a first aspect, the invention relates to use of a rights to use management process, granted to users by a provider, for a first version of a digital object. The process includes the following steps:

(a) totally or partially providing at least one user of a second version of the digital object, derived from the first version;

(b) receiving a use request of at least one subset, no matter how small, of the first version of the digital object, said request being transmitted by said user and including a code of use or referring to a use code;

(c) checking the validity of the use code with a validity repository of the use codes, and the adequacy between the requested use for said subset of the first version of the digital object and at least one use code property associated with the use code;

(d) in case of finding of the validity of the use code, transmitting, to the user, information required for the reconstitution, from the second version of the digital object, of said subset of the first version, for the purpose of the requested use;

(e) updating the at least one validity repository of the use codes, and optionally, at least one of the use properties.

In particular, the provision, during step (a), of the second version of the digital object is performed from one or more remote or local storage medium on a terminal of the user.

According to one aspect of the invention, the provision according to step (a) is free. Thus, the second version of the digital object may be freely disseminated and handled by the users. Furthermore, the first version of the digital object is not available on Internet, including during its use. The second version of the digital object is, as for it, available on any storage device locally or remotely accessible by at least one telecommunication network according to any communication protocol of computer files or of continuous streams, in particular at the addresses provided by the existing or new providers, and/or on physical medium. The use code validity information is, as for it, managed by the controller of the process.

According to one aspect of the invention, the use request may be performed for a subset of the object, no matter how small, in a defined manner by a user.

According to one aspect of the invention, the information required for the reconstitution, from the second version of the digital object, of the first version of the digital object is called decoding information.

The process may further include the following steps:

(a) receiving a prior use request of the first version of the digital object, said prior request being transmitted by said one user;

(b) transmitting to said user, information required to review the use rules which can be authorized by the provider for the first version of the digital object and/or to obtain such rights to use;

(c) establishing an authorization on the basis of said use rules established by the provider or receiving an authorization request transmitted by the provider, relating to said preliminary use request, for the use of the required use of the first version of the digital object; (d) following the establishment of the authorization or the reception of the authorization request, generating and storing in the validity repository of the use codes, a use code associated with at least one use code property and the digital object.

According one aspect of the invention, the use code is independent of the user and his terminal.

The process may also include a step for transmitting the use code to said user.

According to one aspect of the invention, the transmission step of the use code to said user is performed with no identification process of said user nor authentication of the terminal of said user.

The process may further include the following steps:

(a) receiving an registration application as a new provider for the digital object provided by an existing provider, said registration request being transmitted by a user;

(b) transmitting to said user information required to review the provision and acquisition conditions of the rights to use defined by said existing provider for the digital object;

(c) defining the new use rules granted by said user for the digital object and/or to obtain said rights to use, to the extent that the new use rules are in line with the use rules of said existing provider of the digital object;

(c′) establishing an authorization based on rules defined by the existing provider or receiving an authorization request transmitted by the existing provider relating to the registration request of said user;

(d) following the establishment of an authorization on the basis of the use rules defined by the existing provider or the reception of the authorization request transmitted by the existing provider relating to the registration request, registering said user as a new provider authorized to transmit the authorization request or to define the use rules in order to establish an authorization for the use by a user of the digital object.

Thus, the new provider can resell from the conditions of an existing provider, but with the same second version and the same existing decoding information. Thus, there is no creation of new files derived from the first version of the digital object C, and the files remain unique regardless of their networker and the use rules which are applied thereto. In particular, the partial or total copy being possible, the new provider may be authorized to define a new network address, or to keep an existing network address associated with the second version of the digital object.

A unique identifier may be associated with the first version of the digital object, the prior request including said unique identifier. Rights to use and transmission rights may also be associated with the first version of the digital object.

The process may include, prior to the step of the first provision of the second version of the digital object on one of the communication networks, a generation step implemented by:

(a) removing and/or modifying the information of the first version in order to generate the second version;

(b) generating and storing the modified and/or removed information so as to enable the reconstitution of the removed or modified information of the first version and the location of the latter in the second version.

According to one aspect of the invention, following step (a), the second version of the digital object may be copied, stored, and freely transmitted totally or partially by any user.

According to one aspect of the invention, the modified and/or stored information is called decoding information.

During the step for checking the validity of the use code, the validity of the use code is, for example, checked by ensuring that at least one validity condition of the use code request and/or property is met, said at least one validity condition being a function of one or more parameters from the following list without limitation: a provision period of the first version of the digital object, a geographical area, a use(s) authorization number for a given use code, a language, a quality level, a reading terminal type, a technical characteristic of the first version of the digital object, a feature of the first version of the digital object, a payment, balance, a possibility of transmitting and/or assigning the requested right to use, a mandatory descriptive data display.

During the generation step of the use code, use code properties of a use code may be added, taken, in particular from, but not limited to: a number of use authorization for a given use code, typically decremented at each use, a required language, a subtitling, a level of a video game, a quality level, a reading terminal type, a subset of the first version (extract or sequence of extracts), a technical characteristic of the digital object, a feature of the digital object, a mandatory descriptive data display such as watermarking, or author rights and/or reproduction information or <<copyright>> rights.

Optionally, an application can be provided to the user, the application may then be downloaded and executed on the device of the user provided with a processor and at least one transient memory and/or non-transient memory. Said application is then configured so as to:

(a) if the user does not have the second version of the digital object, partially or totally download said second version, for example from a network address specified by the provider, or read this second version directly on a physical medium external or internal to his device;

(b) transmit a prior use request of the first version of the digital object, whose identifier is contained in the second version of the digital object;

(c) receive the information required to review the use rules defined by the provider for the first version of the digital object and/or to obtain a use code associated with at least one use code property;

(d) transmit a use request of a subset, no matter how small, or the entire first version of the digital object associated with a use code;

(e) obtain and reconstitute the first version of the digital object from the decoding information for each requested subset or of the entire first version of the digital object depending on the use code properties;

(f) implement the means required to allow the requested use.

Several options can be provided when obtaining the use code, in particular during the step (c), for example: several use authorizations for the same acquired use code, various subscriptions, payment mode (for example, use of transactional systems with login account such as Paypal™ or new decentralized electronic currencies such as BitCoin™, or by SMS message or by subscription or prepaid credit unit, etc.) which will allow driving the reception programming interface of the Controller of an OK or not, the selected language, a free extract for testing quality, etc. Thus, this received information can be added to the use properties associated, on the one hand, with those selected by the usual provider and, on the other hand with the choice(s) from those provided to said user.

Optionally, the application can be arranged to transmit a provision transfer request of the first version of the digital object.

Optionally, the application can be configured to validate for example as the type of device used by the user, a geographical restriction based on the IP address of the terminal or on its geographical position obtained by a GPS device and to implement the means required to enable the requested use while respecting the use properties already predefined by a provider.

In particular, the first version of the digital object may comprise one or more of the following objects: an audio file, a video file, an image file, photo, an audio stream, a video stream, an image stream, an information stream, an application, or an executable, an alphanumeric document, a data file, a database, a website, an interactive program, a video game.

The process may also further comprise at least one tracking step comprising performing a data storage relating to the operations of generation and use of the use codes and associated use code properties and relating to each use request (DU) of a subset, no matter how small, of the digital object. Regarding the storage medium, the first version is stored to the provider and is never available on one of the communication networks, the second version can be stored in one or more indifferent places and can be gradually downloaded or not, and the decoding information in the system for on-demand dissemination in stream or not.

The process may, in particular, allow modifying, with immediate or planned effect, the use codes, the validity repository of the use codes of the Provider and/or of the new provider at any time, including stopping temporary or permanent use obtaining.

The data relating to the operations of generation and use of the use codes and the associated use code properties can further comprise, for each generated or used use code, the provider from whom this use code has been acquired, and where appropriate, a list of new provider(s) who have successively registered until the acquisition of this use code of said digital object.

Thus, the tracking, allows tracking and storing all the aforementioned operations allowing knowing the purchased, used (how, when and where), use codes or sold by a Provider or a new provider (how and how much) etc . . .

According to a second aspect, the invention relates to a computer program including instructions for executing the steps of the process according to the first aspect, when said program is executed by a processor.

Each of these programs can use any programming language and take the form of source code, object code, executable code or an intermediate code, such as in a partially compiled or interpreted form, or any other desirable form.

According to a third aspect, the invention relates to a recording medium readable by a computer on which a computer program comprising instructions for executing the steps of the process according to the first aspect, is recorded.

The information medium may be any entity or any device capable of storing the program. For example, the medium can include storage means, such as a ROM, a RAM or flash memory, for example a CD-ROM or a microelectronic circuit ROM, or even a magnetic recording means, such as a diskette or a hard drive. On the other hand, the information medium may be a transmissible medium such as an electrical or optical signal which may be routed by an electrical or optical cable, by radio or by other means. The program of the invention may in particular be downloaded over an Internet or

Intranet network. Alternatively, the information medium may be an integrated circuit in which the program is incorporated, the circuit being adapted to execute or to be used in executing the process in question.

According to a fourth aspect, the invention relates to a rights to use management system, granted to users by a provider, for a first version of a digital object. The system includes at least one user terminal adapted to be coupled to a communication network, a second version of the digital object, derived from the first version, being partially or totally provided for the user terminal. The user terminal is adapted to transmit a use request of at least one subset, no matter how small, of the first version of the digital object, and including a use code or referring to a use code. The system further includes a controller module coupled to the communication network, and adapted for:
receiving the use request;
checking the validity of the use code, with a validity repository of the use codes, and the adequacy between the requested use for said subset of the first version of the digital object and at least one use code property associated with the use code;
in case of finding the validity of the use code, transmitting, to the user terminal, information required for the reconstitution, from the second version of the digital object of said subset, no matter how small, of the first version, for the purpose of the requested use;
updating the at least one validity repository of the use codes and optionally at least one of the use properties.

According to one aspect of the invention, the information required for the reconstitution, from the second version of the digital object, of the first version of the digital object is called decoding information.

The user terminal may be further adapted to transmit a registration request as a new provider for the digital object provided by an existing provider, the facilitator module is further adapted for:
receiving the registration request as a new provider for the digital object provided by an existing provider;
transmitting to the user terminal the information required to review the conditions of provision and acquisition of the user rights defined by said existing provider for the digital object;
defining new use rules granted by a user of the user terminal for the digital object and/or to obtain said rights to use, to the extent that the new use rules are in line with the use rules of said existing provider of the digital object;
establishing an authorization based on rules defined by the existing provider or receiving an authorization request transmitted by the existing provider relating to the registration request of said user terminal;
following the establishment of an authorization on the basis of the use rules defined by the existing provider or the reception of the authorization request transmitted by the existing provider relating to the registration request, registration of said user as a new provider authorized to transmit the authorization request or to define the use rules to establish an authorization for the use by a third party of the digital object.

The controller module can also be adapted to check the validity of the use code, by ensuring that at least one validity condition of the use code request and/or property is met, said at least one validity condition being a function of one or more parameters from the following list, but not limited to: a provision period of the first version of the digital object, a geographical area, a number of use authorization(s) for a given use code, a language, a quality level, a reading terminal type, a technical characteristic of the first version of the digital object, a feature of the first version of the digital object, a payment, a balance, a possibility of transmitting and/or assigning the requested right to use, a mandatory descriptive data display (for example, a watermarking, a copyright, an author's name.)

According to one aspect of the invention, the controller module can also be adapted to implement, prior to the first provision of the second version of the digital object on one of the communication networks:

(a) a removal and/or a modification of the information of the first version to generate the second version;

(b) a generation and a storage of the modified and/or removed information so as to allow the reconstitution of the information removed or modified of the first version as well as the location of the latter in the second version.

According to one aspect of the invention, the controller module may be adapted to implement a tracking comprising performing a data storage operations relating to the generation and use of the user codes and the associated use code properties and relating to each use request (DU) of a subset, no matter how small, of the digital object.

According to one aspect of the invention, the data relating to the operations of generation and use of the use codes and the associated use code properties can further comprise, for each use code generated or used, the provider from which this use code, was acquired, and where applicable, a list of new provider(s) who have successively registered until the acquisition of this use code of said digital object

### BRIEF DESCRIPTION OF THE DRAWINGS

Other features and advantages of the present invention will appear in the following description of embodiments with reference to the appended drawings, in which:

FIG. 1 is a block diagram illustrating a set of relationships between various particular entities involved to integrate the users provider of digital object and the users reseller and consumer of uses in the value chain called digital right to follow;

FIG. 2 is a block diagram illustrating these same entities for the input of a digital object of a provider;

FIG. 3 is a block diagram illustrating those same entities for the registration of a reseller of a digital object;

FIG. 4 is a block diagram illustrating these same entities involved during a prior use request of a consumer.

### DETAILED DESCRIPTION

An embodiment based on the techniques of the invention will now be described as well as with its technical environment. It should be noted that it is possible that variations and modifications are made in another embodiment as that described in the present description, in particular with a different technical environment, the latter being understood as one of several acceptable embodiments. In the following description, certain paragraphs are preceded by the term ‘Advantageously’ because they aim to make more comfortable the actions or the interactions between some users and an embodiment of the invention and make clearer the description of the environments of this embodiment.

The invention comprises means such as methods, processes, transient and non-transient data storage, processors, software and systems from which specific entities can be built and provided, for example but without limitation through to programming interfaces (or API, abbreviation of ‘Application Programming Interface’, generally offered by an application library or communication application technologies such as the Web services, Internet, etc. well known to those skilled in the art) in order to meet the needs of applications built over the communication networks such as, but not limited to, those using the WEB technologies and advantageously, in particular to relieve a detailed description of the interactions between the different users of an embodiment, the WEB based applications, denoted APP in this description: an APP is commonly a computer program coded in a programming language supported by browsers, generally able to establish a communication with a network resource, such as, but not limited to, a http server and a generation language of dynamic Web page(s), that is to say Web pages generated on demand, whose content may vary according to information which is known only at the time of its review, well known to those skilled in the art. The APP relies on a standard browser to make the Application executable with possibly the installation of an executable software, such as, but not limited to, the software updates, on the electronic device of the browser user via the communication networks. The APPs are well known to those skilled in the art.

These said particular entities built and described in a following embodiment are put together, a set called <<facilitator>>, generally evidenced by one or more distributed computer (sub-)system(s) on one or more communication networks.

The types of digital objects processed and managed by this embodiment of a facilitator are images, documents such as books, video and/or sound recordings, music, movies, computer applications such as, but not limited to, the video games or the interactive programs, or even all forms of transferable information over communication networks whether in the form of computer files or continuous stream.

The user of a facilitator means any individual, or any capable automatic system, which operates an electronic device such as, but not limited to, a smartphone, a tablet, a laptop, a desktop, a PC, etc. or any computer equipment or system which can be connected to a communication medium such as, but not limited Modem, ADSL, WIFI, 3G, 4G, Cable, Satellite, etc. In this disclosure, the user, which is at a given time stakeholder during an operation of the facilitator, operates such a connected device. Said user is a provider if he provides the facilitator with one or more defined digital object(s) hereinabove that he wants to sell online uses therefrom on one or more communication networks. A user is a reseller if he sells uses a digital object already registered in the facilitator by a provider. He is a reseller of a reseller if he sells uses a digital object already resold by a reseller of said uses identified in the facilitator. A user is called consumer once he is committed in actions to acquire one or more uses of a digital object or, if he has already acquired them, to make one or more use(s) of a digital object identified in the facilitator. These roles of stakeholders are not exclusive to any user of communication networks.

A facilitator manages the accounts of his users who are either providers or resellers or resellers of resellers. The access to these accounts is done for example but not to, limited with a login and a password or through an SSO, well known to those skilled in the art with, for example, but not limited to, a VoD site, a market place, a CMS, etc. An entity of the facilitator who manages these accounts calculates and assigns to each user an identifier. It should be understood that a consumer does not need account or identifier in the facilitator for which the consumer and his electronic device are anonymous. However, in the case of a marketplace (e-commerce, e-merchant, etc.) which uses such a facilitator, said market place may require the acquisition of personal data from their users or even from the device(s) used by said users for the purposes of its economic model or because it is required by their access protection method, and this without any impact on the techniques of the invention and their uses. The identifier of a digital object, registered by a provider in his user account, is calculated and stored by an entity of the facilitator. It should be understood that the identifier of a digital object processed by the facilitator is an invariant of the system, that is to say it is never modified when it is registered either in the account of a provider or in the account of a reseller who is a user other than the provider of this digital object, including when the location of said digital object is modified and/or multiplied or when ‘bonus’ are added thereto, such as, but not limited to, a new subtitling, an individualized ‘watermarking’, etc. The facilitator does not know, that is to say does not store the data file associated with the digital object throughout ‘its merchent life.’

The technical means of the invention are provided a) to securely monetize the online uses of digital objects presented and processed in the form of computer files transferable on communication networks or on hardware media, under the permanent control of their provider, b) to authorize any user of one of the communication networks to resell himself uses of digital objects without departing from the constraints and conditions imposed by their provider, and c) to remunerate said reseller(s). There is no concept of ownership to transfer on sales and resales, the copyrights, the author rights, moral, patrimonial, of reproduction, etc. and any possible distribution licenses are implicitly securely respected thanks to the techniques provided by the invention. A provider may himself be under a same identifier of the facilitator, a reseller of digital objects not owned by him, and vice versa, a reseller can be himself, under a same login of the facilitator, a provider and seller of his own digital objects. The distribution costs, mainly the costs of transfer of the digital objects to the consumers, may be annihilated by distributed computing techniques such as, but not limited to, P2P, P2PTV or WEBRTC, allowing sale and resale prices coherent with the habits of the consumers of digital objects while remunerating the resellers, the provider and the facilitator.

The computer files associated with the digital objects and processed by the techniques of the invention can be used by several users simultaneously, may be duplicated and partially or totally stored in several copies in any virtual or hardware data storage media.

The online uses are readings and/or executions of a computer file when it is downloaded or ‘streamed’ or being downloaded or is already available on the electronic device operated by a consumer. Said user can simultaneously make use thereof in its transfer or delayed after its partial or total transfer on the same device from which he has acquired rights to use or on any other device. The rights to use are acquired by the users through, for example, but not limited to, the payment of an amount which can be cashed directly by the provider or the facilitator or the resellers and can be shared between the provider, the facilitator, the reseller or each one of the possible resellers of reseller. In this example, the shares of the amount due to the provider and the facilitator may be percentages of the sales or resale price or fixed amounts by sold use independently of the sale or resale price or etc. according to the economic model of the facilitator or a marketplace or a VoD site, etc. using the facilitator. The provider may impose different economic models for digital object that he sells the uses thereof.

A provider, besides the remuneration condition mentioned hereinabove as example, may impose constraints and other conditions of the use(s) of its digital object(s), the constraints and conditions may depend on parameters such as, but not limited to, the geographical area of the consumer, local chronological rules. The constraints can be, but not limited to, the geographical area(s) (s), the period(s) of time during which a use is authorized, the number of uses of a digital object allowed with the acquisition of a right to use, the subtitling or dubbing languages , etc. The methods of the invention allow guaranteeing that a reseller might not depart from the constraints of the provider or then will only modify some constraints in a manner subjected to those of the provider such as, but not limited to, a geographical area or a more limited or longer period of time, etc. The provider may however give to the reseller freedom in some conditions such as, but not limited to, the resale price of the uses higher than a minimum amount or if it is lower, in particular in the case of a lending (zero amount) or an invitation (case of consumers identified by an e-mail inviting him to use of a digital object and therefore of a zero amount), etc. against a minimum use fee payable to the provider and the facilitator. This method can be ‘recursively’ applied to the resale of uses of an N+1th reseller of an Nth reseller of uses of said digital object, the constraints and conditions that the N+1th reseller can modify being those possibly modified by the Nth reseller of those of the provider.

Any provider or reseller (respectively, a consumer) may at any time change his access electronic device to his facilitator account, modify his constraints and conditions of use of a digital object, in particular, stop or suspend the use of his digital objects, with an immediate or planned implementation (respectively change the electronic device to use an acquired right to use or resume a voluntarily interrupted use or not) and review and exploit the statistical data of use, in value, in volume and of behavior of the consumers, drawn in detail thanks to the methods and processes of the invention, etc.

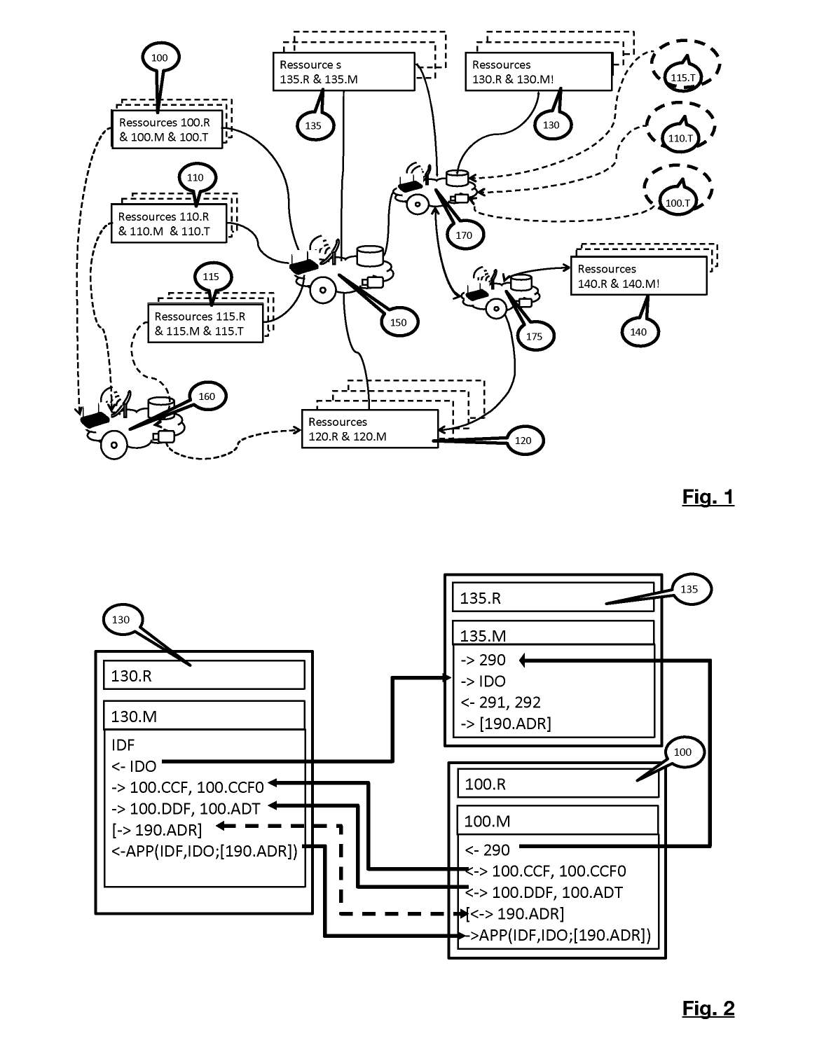

FIG. 1 illustrates an embodiment of a facilitator with the techniques of the invention and its exploitation environment: it depicts the nine types of stakeholders, particular entities or users: the provider(s) 100 of digital object(s) 190 (called C in the text of the claims); the reseller(s) 110; the reseller(s) of a reseller 115; the consumer(s) 120; the computing entity(ies) 135 encoding the digital objects 190 to indexed computer files; the authorization entity(ies) 130, associated with the setting up of the parameters such as the constraints, the conditions and the driving functions (or use code properties called PCU in the text of the claims) of the provider 100, the reseller 110 or the reseller of reseller 115, driving the techniques of the invention for testing, authorizing and drawing the uses; the control entity(ies) 140 associated(s) with the actions of ‘real time’ control of a use and its authorized properties of the digital object 190 by the consumer(s) 120, driving the techniques of the invention; the network resource(s) 130.R, 135.R and 140.R, the storage media 130.M, 135.M and 140.M.

For the sake of simplicity, all possible communications between the nine stakeholders are illustrated with four communication networks 150, 160, 170, 175, in particular the networks 150 and 160 which can be as many or various that there are provider, reseller, consumer each of which can use networks specific to their electronic device(s). Conversely, these four networks may be one and only one such as, for example, but not limited to, a LAN, a WAN, an intranet, an extranet, a private P2P network, etc. The electronic devices operated from the nine stakeholders via the networks 150, 170 and 175 can establish a communication between two of these stakeholders, such as those illustrated by solid lines in FIG. 1, with a server implementing a network resource, such as, but not limited to, a Website, servers provided for example with the ‘php’ language and/or with the ‘Xforms’ dialect, etc. well known to those skilled in the art, an API or an APP, etc. well known to those skilled in the art. The networks addresses are compliant, but not limited to, with the URI standard or ‘uniform resource identifier’, with the URL standard or ‘uniform resource locator’ or with the URN standard or ‘uniform resource name’ as a Magnet link, all well known to those skilled in the art.

The environment of a facilitator may comprise network resources 100.R, 110.R and 115.R, network addresses 100.ADR, 110.ADR and 115.ADR, as illustrated in FIG. 1, associated with the providers, the resellers and the resellers of reseller. The consumers 120 can use electronic devices to access a communication network 150 and establish a communication with one of the servers implementing the network resources 100.R, 110.R and 115.R such as, but not limited to, Websites, ‘landing pages’, blogs, accounts of social networks, email exchange servers, pages accessible in a browser via a search tool, an online advertising, etc.

The environment of a facilitator comprises data storage media 100.M, 110.M, 115.M, as illustrated in FIG. 1. These storage media are associated with the network resources 100.R, 110.R and 115.R such as, but not limited to,

Websites, ‘landing pages’, blogs and constitute any entity managing visibility soutils, such as, but not limited to, CMS, blogs, e-News, <<trackers>>, e-merchant Websites including all entities allowing making visible on the communication networks the digital objects whose uses are promoted and sold by the providers 100 and resellers 110 and 115.

Optionally, the environment of a facilitator may comprise third-party network resources 100.T and/or 110.T and/or 115.T associated with the storage media 100. M and/or 110.M and/or 115.M. Advantageously, they can be directly connected to the authorization entity 130 via an API of the facilitator. They realize, in this embodiment, conditions and constraints of a provider 100 or reseller 110 or 115 that a consumer 120 must meet to acquire uses but which require the intervention of a network resource of a third party such as online payment systems or advantageously of a decentralized electronic currencies, or a management system of specific constraints and conditions involving a third party such as, but not limited to, a geolocation of the third-party system of an electronic device of a consumer, an advertising preview system third-party system before or during or after the reading or the execution of a digital object or even third-party system for sales of ‘goodies’, a subscription system, etc. The network addresses of these said third-party resources are respectively 100.ADT 110.ADT, 115.ADT.

The consumers 120, to acquire and consume online uses of digital object, can use one or more electronic devices to access the communication networks 170 and 175 and to establish a communication, for example, but not limited to, Web Services, with servers implementing authorization entities 130 and stream entities 140.

It should be understood that the particular entities 130, 135 and 140 are designed to drive as many providers 100, as digital objects 190, as resellers 110 and 115 and as consumers 120 of said digital objects that they can support in terms of computing performance, in capacity and input/output stream of their data storage media or even by debiting their input/output devices with local or remote external resources. The techniques and methods of the invention, in particular the architecture supported by the networks 170 and 175 and the fact that all the data structures are by native design, simple indexed sequential files without sharing data, naturally and automatically allow duplicating these entities as required, that is to say as and when the number of providers, of digital objects, of sellers, in particular of consumers increase. The underlying computer techniques are well known to those skilled in the art, such as conventionally the distribution agents such as, but not limited to, schedulers, load balancers, the protocols, CDN, P2P, etc. but also more generally the distributed computing technologies including, but not limited to, the CSP paradigms, IPC, etc. of future Internet which, as of now, with benefits in terms of modularity, security, efficiency and performance, may be the system and software building bases of a facilitator from the techniques of the invention without any impact on the techniques, claimed methods and processes. So far, some features of the future implementations of these paradigms can be approximated by techniques well known to those skilled in the art, such as, but not limited to, the ‘fork’ of the Posix programming standard or, but in a more laborious and delicate manner, the ‘(multi-) threads’.

The provider 100 is, but not limited to, a creator of digital objects, an author, an aggregator and distributor of rights holders or their representatives, etc., an digital objects provision automatic system such as, but not limited to, a

CMS or camera digital output filming an event and transmitting the images in a format compatible with one or more communication networks or even a broadcast service provider and/or digital streams multicast.

In all cases, the online rights to use of digital objects 190 are intended to be sold anonymously, or lent or given as gift or sent by invitation, then to an identified user, to any user connected to a communication network such as, but not limited to, Internet. It is then essential to preserve the rarity of the digital objects, that is to say their market value or even to guarantee the protection of the uses of the digital objects and the access to the rights to use in accordance with the wishes of the provider 100.

The provider 100 is referenced by an account of the facilitator managed by the authorization entity 130 which calculates and assigns the identifier IDF thereto. In order to register a digital object 190 in his account (FIG. 2), the provider transmits in a first step the computer file 290 associated with said digital object to the computing entity 135 which processes it according to a method described hereinafter. In case of success of the processing, the entity 135 establishes a communication via the network 170 with the storage media 130.M of the authorization entity 130, which calculates a unique identifier IDO of said digital object, stores it in the storage media 130.M, indexed by the identifiers IDF and returns it to the computing entity 135 via the network 170. The provider 100 or his partners or subcontractors may have his own network resource 100.R and a storage media 100.M, with a network address 100.ADR. The provider 100 manages therein, inter alia, the descriptive data of the digital object 190, such as, but not limited to, the one or more synopsis, the network addresses for access to video(s) and/or one or more documents of ‘teasing’ or site(s) or blog(s), the network address(es) to other digital objects of the provider 100, etc., the required descriptive data (not modifiable) 100.DDF specifying some of these said data which must be necessarily resumed and displayed by the electronic devices of the consumer 120 during uses such as, but not limited to, the copyright(s), a watermarking, etc., the data 100.CCF specifying the constraints and conditions imposed by the provider for the acquisition of uses by the consumers 120 and the data 100.CCF° specifying the modification limits of some of these said constraints and conditions allowed to a use reseller of said digital object, for example, but not limited to, a minimum and/or maximum of the sale price of a use or the geographical areas or time periods of validity of a use which can be limited or extended, etc. The implementation of these data can be planned in the moment or later. The provider may at any time update said data including prohibiting or suspending any use of the digital object 190 already distributed via the communication networks 150 or 160 or on hardware medium.

Advantageously for the security of these data and for the sake of comfort and a greater independence of the providers 100 and that of the resellers 110 and 115 described hereinafter, the provider 100 can transfer or directly input the data 100.ADR, 100.DDF 100.CCF and 100.CCF°, via the networks 150 and/or 170 in the entity 130 which stores and manages them on behalf of the provider in the storage media 130.M indexed by the identifiers IDF and IDO. This optional method is chosen (FIG. 2) for the rest of the description in order not to obscure the presentation unnecessarily with the description of numerous information exchange (or dialogues) but trivial, well known to those skilled in the art.

Generally, the processes driving some constraints and/or conditions of a provider 100 may require the intervention of a third-party network resource 100.T as described hereinabove. The network resource 100.R, the storage media 100.M or in the optional case hereinabove, the network resources 130.R and the storage media 130.M can use electronic devices to access the network 150 or 170 and establish an API type of communication with the server(s) implementing this said third-party network resource with a network address 100.ADT. The consumers 120 can use their electronic device to access the network 150 and establish a customer/server communication type with the server(s) implementing this third-party network resource 100.T and to meet the conditions that said resource is responsible for acquiring one or more right(s) to use. This third-party network resource 100.T transmits via the networks 150 or 170 the information to a network resource 130.R and/or a storage media 130.M indexed by IDF and IDO if the conditions have been met or not by the consumers and/or resellers. This information may optionally be filled either in the case of a refusal by the constraints or conditions which have not been checked such as, for example, but not limited to, the absence of a payment, or by an information allowing, for example, confirming the respect of the constraints and conditions, such as for example, but not limited to, the amount actually paid. In the case of a negative answer, the request of the consumer and the processes which followed it in order to acquire a right to use of the digital object 190, are stopped and a provided message is sent to the electronic device of said consumer. In the following detailed description and in any situation in this way, it is assumed that the answer is affirmative.

Advantageously for the present description of the facilitator, it was chosen as an example of access to the rights to use acquisition device of digital objects by the consumers, the technique of the Web based applications, commonly called APP described herein. This type of technique, well known to those skilled in the art, easily allows and must be understood in a secure manner thanks to the techniques of the invention, the anonymity and a ‘maximum’ comfort in the use of a facilitator by the consumers and the resellers of digital objects. In another embodiment, this technique can be more basic by including several trivial information exchanges (which may include the exchange of emails), well known to those skilled in the art and without impact on the claimed techniques of the invention, but whose description would obscure the present detailed description of a facilitator. It must be understood that, thanks to the architecture imposing a stream of the unidirectional parameters from server to server, any change of one of the parameters, voluntary or involuntary, of an APP by a user will default the setting-up system of a use of the digital object 190. Similarly, the authorization(s) acquired by a consumer will be implicitly secure with the concept of informed APP by a unique use code, regardless of the electronic device used by a consumer during a use. The concept of claimed use code and communication inter-servers are described hereinafter.

Once all these authorization data for the uses of the digital object 190 and the network address 100.ADT input by the provider 100 via the network resource 130.R and stored on a storage media 130.M indexed by IDF and IDO, said medium ‘manufactures’ and stores a set APP, APP (IDF, IDO, 190.ADR, etc.) where 190.ADR is a network address where the resulting file 291 is commonly stored (called C′ in the claims) of the computing entity 135, described later. The provider can modify this storage location at any time, and then this network address as described hereinafter. This APP may be transferred on the storage media 100.M via the networks 170, 150. The provider 100 or any automated system can insert this APP in any means or content visibility tool such as, but not limited to, any page interpretable by a usual browser or in emails or hardware medium, etc. When a user ‘clicks/opens’ said APP (IDF, IDO, 190.ADR, etc.) from an electronic device, its execution on said device establishes a communication with a storage media 135.M and, if required downloads a process PR0 either because said device has no cedit or because a new update of this said process is available on the storage media 135.M, executes the process PR0. The process PR0 is described hereinafter.

A reseller 110 is any communication network user who wants to resell uses of a digital object 190 of a provider 100 and to possibly receive a bonus from said provider 100, such as, for example, but not limited to, a percentage of its own sales. It can be an amateur such as, but not limited to, a prescriber, a blogger or a fan, etc. or professional such as, but not limited to, an aggregator or distributor, a representative, etc.

The aim of the invention is that the reseller 110 can freely disseminate and sell uses of said digital object with his own tools and methods of communication and sale without it can modify the required data 100.DDF or depart from the constraints and conditions 100.CCF and the modification rules 100.CCF° imposed by the provider.

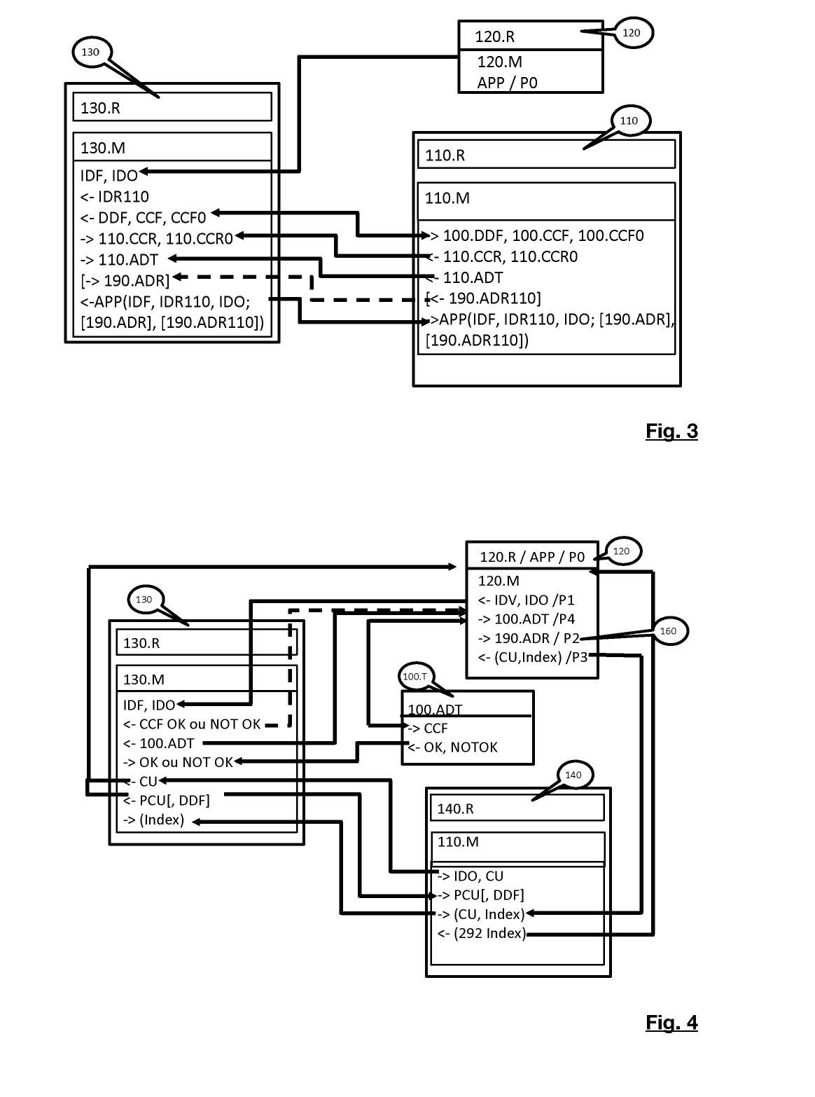

If he has not already an identifier in the facilitator (FIG. 3), said reseller opens a user account of the facilitator via the network resource 130.R of the authorization entity 130; the storage media 130.M calculates and assigns him the identifier IDR¹¹⁰ and register in said account the identifier IDO of said digital object. If the reseller already has an identified account IDF or IDR^{xyz} in the authorization entity 130, then the identifier IDR¹¹⁰ can be equal to said identifier or IDF or IDR^{xyz}, that is to say under a same account, a user can be both provider, reseller and/or reseller of reseller.

Via a communication network 150, the access network resource 130.R transfers for display on the electronic device of said reseller 110 the required data 100.DDF, the constraints, the conditions and the modifications allowed 100.CCF and 100.CCF° . After that the reseller 110 has specified the data selectable from the 100.RTC° , the latter are merged with the data 100.CCF to provide the constraints and the conditions 110.CCR° and any possible modifiable data PR0 which are then stored in the data storage media 130.M indexed by the identifiers IDF, IDR¹¹° and IDO. The entity 130 builds, as for the provider, a parameters APP (IDF, IDR¹¹⁰, IDO, 190.ADR, 190.ADR¹¹⁰) described hereinafter. As for said provider, the resellers 110 may have their own network resource 110.R of network address 110.ADR, a storage media 110. M and a third-party network resource 110.T of network address 110.ADT.

A reseller of reseller 115 is any communication network user who wants to resell uses of a digital object 190 of a provider 100 and possibly benefit a gratuity from said provider 100 and/or reseller 110, such as, for example, but not limited to, a percentage of his own sales. It can be an amateur, but not limited to, a prescriber, a blogger or a fan on social networks, etc. or a professional such as, but not limited to, an aggregator or distributor, a representative of right holders, etc.

The aim of the invention is that said reseller of reseller 115 can freely disseminate and sell uses of said digital object with his own tools and methods of communication and sales without being able to change the required data 100.DDF or depart from the constraints and conditions 110.CCR and the modification rules 110.CCR° , imposed by said reseller.

If he has not already an identifier in the facilitator, said reseller of reseller 115 opens a user account of the facilitator via the network resource 130.R of the authorization entity 130; the storage media 130.M calculates and assigns him the identifier IDR¹¹⁵ and register in said account, the identifier IDO of said digital object. If the reseller of reseller has already an identified account IDF or IDR^{xyz} in the authorization entity 130, then the identifier IDR¹¹⁵ can be equal to said identifier IDF or IDR^{xyz}, that is to say under a same account of the facilitator, a user of facilitator can be both provider, reseller and/or reseller of reseller.

Via a communication network 150, the access network resource 130.R transfers for display on the electronic device of said reseller of reseller 115 the required data 100.DDF, the constraints, the conditions and the modifications allowed by the reseller 110, 110.CCR and 110.CCR°. After the reseller of reseller 115 has specified the selectable data among the 110.CCR°, they are merged with the data 100.CCF to provide the constraints and conditions 115.CCR and any possible modifiable data 115.JRC°, which is then stored in the data storage media 130.M indexed by the identifiers IDF, IDR¹¹⁰ IDR¹¹⁵ and IDO. The entity 130, build as for the provider, a parameters APP (IDF, IDR¹¹⁰, IDR¹¹⁵, IDO, 190.ADR, 190.ADR¹¹⁰ 190.ADR¹¹⁵). As for the provider 100 and the reseller 110, the reseller of reseller 115 may have his own network resource 115.R of network address 115.ADR and storage media 115.M and a third-party network resource 115.T of network address 110.ADT.

It must be understood that this description of a reseller of reseller can be extended with that of a reseller of reseller of reseller and so on. The description hereinabove recursively coarsely continues and this succession, which will not be described further before, is claimed in the present invention.

Once all these authorization data for the uses of the digital object 190 and the network address 110.ADT (115.ADT respectively) input by the reseller 110 (reseller of reseller 115 respectively) via the network resource 130.R and stored on the storage media 130.M indexed by IDF, IDO, IDR¹¹⁰ (and IDR¹¹⁵ respectively), said storage media builds and stores an set APP, APP (IDF, IDR¹¹⁰, IDO, 190.ADR, 190.ADR¹¹⁰, etc.) (respectively APP (IDF, IDR¹¹⁰, IDR¹¹⁵, IDO, 190.ADR, 190.ADR¹¹⁰, 190.ADR¹¹⁵, etc.)) where 190.ADR¹¹⁰ (190.ADR¹¹⁵ respectively) is a new network address of the file 291 provided by the reseller 110 (respectively 115) which has eventually modified the storage location of the file 291 as described later. This APP is transferred to the storage medium 110.M (respectively 115.M) via the networks 170, 150. The reseller 110 (respectively 115) or any automatic system can insert this APP in any means or content visibility tool such as, but not limited to, any page interpretable by usual browser or in email or any hardware medium, etc. When a user ‘clicks/opens’ said APP (IDF, IDR¹¹⁰, IDO, 190.ADR, 190.ADR¹¹⁰, etc.) (respectively APP (IDF, IDR¹¹⁰, IDR¹¹⁵, IDO, 190.ADR, 190.ADR¹¹⁰, 190.ADR¹¹⁵, etc.)) from one of his electronic devices, its execution on said device establishes a communication with a computing entity 135 and, if required downloads a process PR0 either because said device does not have process credit or because of a new update of process credit is available on the storage media 135.M, executes said process PR0 described hereinafter.

It must be understood that a provider 100 (respectively a reseller 110 or a reseller or reseller 115) can at any time, update or modify his data 100. 100.DDF 100.CCF 100.CCF (respectively 110.CCR, 110.CCR° and 115.CCR and 115.)CCR° stored in the storage media 130.M via the network resource 130.R or partially managed by the third-party network resource 100.T (110.T and 115.T respectively). An alert message by the provider (said reseller 110 respectively) is then transmitted to said reseller 110 (115 respectively) whose constraints and conditions 110.CCR (115.CCR respectively) can be impacted by said updates or modifications.

The digital object 190 (called C in the claims) is transmitted by its provider 100 to the computing entity 135 as a computer file, the original file 290, indexable by any criterion such as, but not limited to, space, time, syntactic, semantic, criterion etc. More generally, a computer file is indexable if it is possible to determine a sequence of indices after locating a unitary element, such as a byte in the file such that, from an index, it is possible to read or execute the sequence of unitary elements contained in the file and which follow this index until at least one next index: for example, but not limited to, the ‘time codes’ of the frames ‘I’ of a compressed file according to the MPEG standard, the number of page or paragraph of a document, the instructions waiting for an answer to an action of a user of a video game, the coordinates of a block of pixels in an image, the codes of start of paragraph or the comma in a text, etc. The computing entity 135 separates the original file 290 into two parts: the file 291 (called C′ in the claims) is the original file 290 of which, for each or some of the indices, the information following this index and preceding the next index is partially or totally modified. The modification process P290, and if required the inverse process P290ᵢ¹, are saved for each index in the second part, the file 292 (called C″ in the claims). The sets of indices of the files 291 and 292 are in biunivocal correspondence with that of the file 290 thus coarsely ensuring the synchronization of the information between the three files 290, 291 and 292.

Optionally, for safety purposes in the transfer of the information between the entity 140 and the electronic device of the consumer as described hereinafter, the processes P290; may be composed in mathematical sense of the term with a bijection F290ⱼₖ(i) such as, but not limited to, the permutation functions, and the inverse function F290ⱼₖ⁻¹ for the indices ‘i’ comprised between j and k such as, for example, but not limited to, the indices delimiting the information to be transferred in the ‘buffering’ techniques well known to those skilled in the art.

This separation method amounts to distinguish the distribution actions of a digital object, on one or more communication networks or hardware media, online use actions of said digital object. The ‘good’ processes {P290ᵢ} to ‘manufacture’ the two files 291 and 292 are such that one is useless without the other in order to reconstitute index by index the original file 290 and that the file 292 has a size as small as possible. It is clearly possible to use in the present invention a sharing of the original file besides the two parts without modifying the techniques of the provided invention but at the cost of an obscured, useless description of an embodiment of a facilitator. However, this possibility is claimed by the present disclosure.

There are methods for separating a searchable computer file into two parts which can be synchronized according to which one can be useless without the other. It is not the intention of this disclosure to select one or to disclose a new therefrom; two are described as they illustrate an interesting characteristic allowed by the methods and techniques claimed in the invention:
A generic and easily implemented method comprises resuming the original file 290 as the file 291 for which is defined a set of pseudo-random index, that is to say not necessarily taking into account the format of the data, or semantically, that is to say taking into account the format of the data of the original file 290. For each index ‘i’ or for some of them, the information of the file 291 located between the indices ‘i’ and ‘i+1’ are totally or partially encrypted (respectively encoded) with, for example, but not limited to, a technique AES key KEYⁱ (respectively with an encoding bijection of an information sequence indexed to a big integer), called process P290ᵢ, then saving, in the location of index ‘i’ of the file 292, said decryption key (respectively said big integer). When required, the transfer of the key KEYⁱ (respectively said big integer) to the electronic device of a consumer for the decryption (respectively the decoding), the process P290ᵢ¹, can advantageously be performed with, for example, but not limited to, a technique RSA well known to those skilled in the art (respectively the arguments of the inverse bijection). In both cases, the authentication of the servers and the electronic device of the consumer, which is the most costly and complex operation to be implemented in the security systems, generally used in the DRM, and the most restrictive and intrusive for the user, is useless in this invention. As described hereinafter, the architecture of the distributed system of the invention and the concept of single-use code natively makes this authentication absolutely safe without taking into account any identification of the electronic devices of the users or even the servers of the system. It is about a characteristic claimed in the present invention relative to the PTM techniques of the DRM generally used.

A method specific to the compressed files 290 comprises to modifying coefficients of a compression table such as, for example, in the case of the MPEG compression: some coefficients of the frames Iⁱ and/or Pⁱ and/or Bⁱ corresponding to the time-code Tⁱ. In this example, the file 292 contains for each index I the process P290ᵢ to locate these coefficients in the modified frames and the original coefficients and possibly a process P290ᵢ¹ to reconstitute the original frames of the file 290 on the electronic device of the consumer 120. A high-performance technology of this type has been disclosed in the patent FR2867928. Other examples apply to the images compressed by the JPEG standard or called Wavelets. This type of method is also adapted and easily integrated into the techniques and methods claimed in the invention.

These two methods, which illustrate the mixed use or not of the encryption techniques and the encoding techniques allow obtaining files 292 of a size, in particular, small and simple processes P290ᵢ and P290ᵢ¹ but lends itself well to the performance of the facilitators targeted by the invention.

The entity 135 sends a request for calculating a unique identifier IDO of said digital object 190 to the storage media 130.M via the network 170 (FIG. 2).

The storage media 130.M, indexed by identifiers IDF, IDO returns via the network 170 of the identifier IDO to the entity 135 which inserts it in the file 291, advantageously, first thing in the file, before its distribution. The entity 135 transmits via the network 170 the file 292 to a storage media 140.M, indexed by the IDO identifier and distributed over the networks 170 and/or 175 according to the distributed storage techniques, which may include those using the protocols called P2P protocols, well known to those skilled in the art.

The computing entity 135, once the two files 291 and 292 calculated, deletes the original file 290, optionally gradually. Advantageously, in another embodiment of a facilitator, in order to raise the highest level of protection of the 290 files and of conviviality in the use of a facilitator, in particular by one or a group of providers having many digital objects, the calculation instructions of the entity 135 can be remotely driven by the entity 135 on the same device of the provider 100 according to techniques of ‘on-the-fly compilation’ and of reversed ‘remote procedure call’, well known to those skilled in the art. It must be understood in this case that the original computer file 290 associated with the digital object 190 never exists in the entity 135.M nor in any other component of the facilitator and its environment and is never transferred to the communication networks. It remains on the providers own storage media which is thus the only guarantor of the protection of his original file.

The file 291 is self-protected and identifiable and can be transferred or distributed throughout the communication network 160. It may be, partially or totally, implanted in several copies, on any storage media such as, but not limited to, in the ‘Distributed Data Centers’, in the ‘Content Delivery Networks’, the ‘Named Data Networks’ etc., In hosting centers of shared servers, in the individual servers such as, but not limited to, the electronic devices of the users provided with a network server software or a customer/P2P server, or even via online storage services, for example, those offered by Internet providers, and sharing services of files and copies of files or of direct download etc. or even on hardware media such as, but not limited to, internal and external hard drives, CD, DVD, USB drives, memory cards, etc. The architectural, systems and methods characteristics claimed by the invention allow the use of these separation methods without authentication process of the consumers with a single file 291 distributed freely and independently of the required data 100.DDF and of constraints and conditions 100.CCF 110.CCR and/or 115.CCR. Each provider, reseller and reseller of reseller is free to store the file 291 to a (local or remote) network address 190.ADR, 190.ADR¹¹⁰, 190.ADR¹¹⁵. He will be responsible to inform the access APP of the use acquisition with this network address, which may be unknown to the facilitator.

The consumer 120 is any user of a communication network which wishes to acquire one or more rights to use of a digital object 190 which has been processed by a facilitator. In order to simplify the explanation, but not limited to, said consumer is aware and want to make use of the digital object 190 through the network resource 100.R (respectively 110.R or 115.R) or any entity accessible on one of the communication networks such as an e- commerce site, a result provided by a search tool, in a ‘torrent package’, in an email, on a blog or on any hardware medium, etc. These entities have, optionally and advantageously included the APP described hereinabove provided by the storage media 130.M and published by the provider (the reseller or the reseller of reseller respectively). The access to the acquisition of the right to use can be made of any other way such as, but not limited to, by directly opening a download link of a file 291, or the file 291 itself on a hardware medium or already downloaded on a storage media of the electronic device of the consumer, etc. The APP is actually an example of access among others which makes transparent, operations performed between the device of the consumer and the servers supporting the techniques of the invention in order to acquire a right to use. This approach has become common with the generalization of the access to browser pages on most communication networks.

Once the APP (IDF, IDR¹¹⁰, IDR¹¹⁵, . . . ; IDO; 190.ADR, 190.ADR¹¹⁰, 190.ADR¹¹⁵ . . . ) enabled, the latter will establish via network 150, as described hereinafter, communications with the entities 130, 135 and 140 (FIG. 4).

The APP, executed on the electronic device 120.R of the consumer 120, establishes a communication with the entity 135 to download the process PR0 or its latest update by the facilitator, if required. Said process PR0 comprises several components:

PR1 determines the seller IDV for this preliminary use request (called DPU in the claims) of the consumer 120, for example in one embodiment, the last of the nonzero parameters IDF, IDR¹¹⁰, IDR¹¹⁵, . . . of the APP. PR1 establishes a communication with the entity 130, sends the parameters IDV and IDO to this entity then waits for an OK answer indicating that there is a provider or a reseller or reseller of reseller IDV of a digital object 190 associated with the identifier IDO and managed by the entity 130. The OK answer also means that no constraints contained in 100.CCF if IDV=IDF or if IDV. CCR prevents the acquisition of a use by the consumer. Then, PR1 waits for a use code, called CU in the claims, from the entity 130. At the reception, PR1 informs the APP with this use code CU for a subsequent use application. In another situation, the APP is already filled by a use code CU, the process PR0 knows then a use code CU for the digital object IDO that it shares with PR1. PR1 sends to the entity 130 this use code CU at the same time that the identifier IDO of the digital file 190 then waits for an OK answer. In both cases, PR1 then shares the use code CU with PR3.

PR2 tests, in parallel, whether the file 291 associated with the digital object 190 with the identifier IDO is present on an internal or external storage media 120.M of the device 120.R of the consumer 120. If yes, PR2 starts reading the file 291 until reading the identifier ID which has been registered therein by the entity 135 during its construction and ensures the equality with the parameter IDO of the APP. If not, PR2 downloads the file 291 at the address 190.ADR if IDV=IDF 190.ADR^{IDV} according to the file transfer protocol adapted to the format of the file 291. PR2 starts progressively reading this file until reading the identifier IDO which has been registered therein by the entity 135 during its construction and ensures the equality with the parameter IDO of the APP. In both cases, if the two are different, PR2 stops the process with a message informing the consumer of an error, otherwise and in the second case, PR2 continues independently downloading of the other components of PR0 and progressively stores the file 291 on the storage media 120.M of the.

PR3 establishes, in parallel, a communication with the entity 140 via the networks 170 or 175 and opens a network session with the entity. PR3 is queued to receive a use code CU via PR1. PR3 sends the use code CU to the entity 140 then sends as many use requests (called DU in the claims) of a subset, no matter how small, of the digital object 190 to the entity 140. PR3 receives the information of the file 292 associated and corresponding to the indices of the subset of the digital object 190 whose use is requested and transmitted by the network resource 140.R. PR3 executes the process(es) P290ᵢ¹ to reconstitute by piece (each constituting the subsets referenced in the claims) the original index file by index on said device. Optionally, PR3 receives from the entity 140 the required data 100.DDF which will be attached to the file ‘pieces’ reconstituted and transferred to the reading or execution process adapted to the format of the original file 290 installed on the device of the consumer 120. Optionally, these required data 100.DDF are received by the process PR3 at once either from the entity 130 or the entity 140 during a use request.

PR4 receives, in parallel, from the entity 130 the conditions 100. CCF if IDV=IDF or IDV.CCR that the consumers 120 must respect or fulfill to acquire a right to use and use properties which will be granted thereto with an acquired use code. Advantageously, in this embodiment (FIG. 4), in order to prevent any customer/server communication between the device of the consumer 120 and the entity 130 of the facilitator, the conditions 100.CCF if IDV =IDF or IDV.CCR are located and managed in the third-party network resource IDV.T (100.T or 110.T or 115.T) in which case the information received from the entity 130 is the only network address IDV.ADT (100.ADT, 110.ADT, 115.ADT respectively). PR4 establishes a customer/server type communication with the third-party resource IDV.T and meets or not the conditions requested therefrom which may depend on the use properties of a use code chosen by the consumer in this relationship, for example, but not limited to, a prize according to the subtitling, a price per quantity of requested uses, a price according to the requested quality of reading, the input of a use code or a subscription, etc.

Other processes, not described in this disclosure, are executed on the device of the consumer 120 such as various conventional tools for reading or executing a digital object adapted to the type of said object, subtitling and/or watermarking tools, processing tools for each of the required data such as the display of one or more copyrights, sending tools, to the storage media 130.M indexed by the use code CU and optionally and advantageously the number of the network session opened by the component PR3, events tracing the uses modes and the actions of reading or execution of the consumer during the use of a digital object, etc.

The process PR0 knows the use code clearly received and informing and customizing the APP installed on the device of the consumer 120. The consumer 120 may then
either immediately use his rights (according to progressive download techniques well known to those skilled in the art when the download process PR2 is in progress or after this download but during a same network session), in which case the sending of the use code to the entity 140 will be automatic and transparent for the consumer,
or use his rights later and/or change device after having acquired this use code or the like, in particular in case where the use properties of a use code qualifies for several use authorizations, and the consumer must input this use code when requested by the facilitator. This latter manual mode can be clearly automated if the resumption is performed from the same electronic device of the consumer or if the APP, once filled, has been copied or transferred to another device.
In the case where the number of authorization of a use code is equal to one and where the consumer makes immediate use thereof, or during a same network session, the use code may be eliminated in the processes described hereinabove. These use cases, restrictive for the consumer, which is found in purely functional terms in the standard offers (S)MoD, (S)GoD (S)VoD but intrusively and without the possibilities of self-protected distribution, friendly and anonymous support, resale or lending of the uses of digital objects of the present invention, are claimed in the invention.

The actions operated by the entities 130 and 140 when requesting use of a digital object 190 by a consumer 120 are (FIG. 4):

In a first situation, one of the entities 130 of the facilitator receives a request establishing a communication with a device of a user of the facilitator and receives the parameters IDV and IDO (prior use request DPU). The storage media 130.M tests whether the account IDV of the digital object IDO is registered and tests whether the uses constraints 100.CCF if IDV=IDF or IDV.CCR are compatible with the environment of the device of the consumer 120, such as, for example, the geolocation constraint, and the status of the digital object IDO: available use, suspended use, deleted use, etc. If so, 130.R sends an OK to the device of the consumer 120 and, in this embodiment of the facilitator where conditions are managed by a third-party entity of the provider or the reseller of reseller in order to simplify the present detailed description, the network address IDV.ADT of the third-party network resource IDV.T. The entity 130 establishes an API type communication (setting up when registering said digital object and/or of the provider or the reseller or the reseller or reseller) with the third-party network resource IDV.T and possibly sends the data 100.DDF and some other information stored in the storage media 130.M indexed by IDV and IDO and is waiting for an OK answer, indicating that the consumer 120 has met the conditions required by the provider IDF if IDV=IDF or of the reseller IDV, or NOT OK. Then, the entity 130 calculates a unique use code CU, associates with this use code, use properties PCU and establishes a communication via the networks 170, 175 with one of the entities 140.

In a second situation, one of the entities 130 receive with the request establishing a communication with a device of a user of the facilitator, a use code CU (use request DU). The storage media 130.M indexed by CU, IDF, IDV, IDO tests the existence of this code CU, tests whether the constraints of uses 100.CCF if IDV=IDF or IDV.CCR are compatible with the current environment the device of the consumer 120, such as geolocation constraint or even, according to the decision of the provider 100, the status of the digital object IDO (available or suspended or deleted use), etc., and tests whether the use code CU is always compatible with his properties, in particular, but not limited to, if the number of use authorization is reached or not. If OK, in the latter situation, the entity 130 does not establish communication with the third-party entity IDV.T. If NOT OK, the entity 130 sends a message adapted to the process PR0 executed on the device of the consumer 120 and stops the process.

The entity 130 establishes a communication with one of the entities 140 and, in the first situation, sends the use code CU and the properties PCU to the process PR0 executed on the device of the consumer 120 and, in both situations, sends to said entity 140 the use code CU, the identifier IDO and optionally, the required data 100.DDF.

The entity 130, throughout the network session(s) associated with a use code CU in use by a consumer, receives the information related to actions operated by the consumer during the authorized use of the digital object 190 and stores them in the storage media 130.M for a ‘real-time tracking’ which may be reviewed by the provider IDF and his possible reseller(s) IDV or for statistical data and the distribution calculations of the remuneration between the facilitator, the provider and his possible reseller(s) of the uses of the digital object 190. In particular, the entity 130 receives from the entity 140, the information relating to the operation of the communication between the entity 140 and the device of the consumer 120, in particular the index (or subset) from which the consumer requests the use and the information of the voluntary stopping or not of a use. This information allows the storage media 130.M to complete the statistical data and to update use properties of the use code CU, in particular to decrement the number of use authorizations used with the use code CU.

One of the entities 140 of the facilitator receives a request establishing communication of one of the entities 130 of the facilitator, receives and stores the use code CU, the identifier IDO and optionally the PCU properties or even the required data 100.DDF of the digital object 190. The entity 140 seeks, if required via the networks 170, 175 managed in a distributed manner, among the entities 140 of the facilitator, the storage media 140.M containing the file 292 associated with the identifier digital object IDO and downloads it on its own storage media or interchanges the communication with the entity 130 with this said entity 140, or even any other method known to those skilled in the art, in distributed computing. Said entity 140 is waiting for a request establishing a communication with a device of a consumer 120 informed by said use code CU. One of the entities 140 of the facilitator receives a request establishing a communication with the device of a consumer 120 informed by said use code CU, either the entity 140 is that waiting for such a communication set-up or it searches for the entity 140 which has received it via the networks 170, 175 managed in a distributed manner and interchanges the communication with this said entity 140, or any other method known to those skilled in the art in distributed computing. Said entity 140 is queued for use request reception from a subset, no matter how small, of the digital object in the form of an index positioning in the file 292 the information to be unidirectionally transferred as well as the required data DDF to the process PR3 of the process PR0 executing on the device of the consumer 120. Said entity 140 sends to the entity 130 which stores in its storage media 130.M any information relating to the operation of the communication between the entity 140 and the device of the consumer 120, in particular the index (or subset) from which the consumer requests the use and the index to which the consumer requests stopping the use or to which a non-voluntary interruption has occurred. For information, the latter case allows resuming a use with another network session but a same use code, such as, for example at the exit of a tunnel not equipped with communication means with one of networks used for this use.

The techniques of the invention, in particular the separation of the digital object distribution actions of that of its uses, advantageously coupled with the concept of third-party network resource and use property of the use codes allowing supporting any kind the economic model of the facilitator, of the paying consumption and distribution of income between the provider of a digital object and his reseller(s):
A distribution of the incomes of the consumptions paid to the act of between the stakeholders of the facilitator in percentage terms with possibly an additional share to the resellers bringing added value such as, for example, but not limited to, compilations of extracts, subtitling or new dubbing, etc.
A purchase prepayment process of use codes to the facilitator by the provider, to the provider by a reseller, etc. with a pricing for unlimited quantities or number over a given period of time (periodic subscription for example), etc.
a consumption by the ‘native advertising’, purchasing of goodies managed for example by third-party network resources, etc.
Any mode combining these models

A template can be customized for each digital object of a provider, for each provider, etc.

A network such as 150, 160, 170 or 175 may be any type of communication network including, but not limited to, Internet, local area network LAN or wide area network WAN, a cabled network, a telephone network, etc. provided with communication protocols adapted to a physical or wireless medium, etc.

An electronic device such as a user 100, 110, 115 or 120 can use, may include a personal computer, personal digital assistant or other computing device capable of communicating on a network, including, but not limited to, mobile phones, the ‘set-top-boxes’, the tablets, the computers ‘laptop or desktop’, the game consoles, the readers of books, the network servers, etc.

A data storage media such as 100.M, 110.M, 115.M, 120.M, 130.M, 135.M, 140.M, may be any medium which can be used to store information and make it accessible by one or more processors, implementing instructions realizing actions proper to each of the functions described in this disclosure. A storage media includes, but not limited to, the random access memories (RAM), the read only memories (ROM), the electrically erasable and/or programmable memories (EE-PROM), the flash memories, the CD-ROM and DVD or other optical storage, the magnetic storage devices, etc.

A network resource can be either an electronic device or one or more servers, including the ‘data centers’ or several ‘data centers’. It can comprise one or more processors and a memory, transient or non-transient, including one or more data storage media. The one or more processor(s) are configured to execute the instructions stored in said memory.

1. A process for managing rights to use, granted to users by a provider, for a first version of a digital object, comprising:
(a) totally or partially providing a second version of the digital object, derived from the first version for at least one user;
(b) receiving a use request of at least one subset of the first version of the digital object, said request being transmitted by said user, and including a use code or referring to a use code;
(c) checking the validity of the use code, with a validity repository of use codes, and the adequacy of the use requested for that subset of the first version of the digital object and at least one use code property associated with the use code;
(d) in case of finding the validity of the use code, transmitting to the user, information required for the reconstitution, from the second version of the digital object, of said subset of the first version, for the purpose of the requested use;
(e) updating the at least one validity repository of the use codes and optionally at least one of the use properties.

2. The process according to claim 1, further comprising:
(a) receiving a prior use request of the first version of the digital object, said prior request being transmitted by said one user;
(b) transmitting, to said user, information required to review the use rules which can be authorized by the provider for the first version of the digital object and/or for obtaining said rights to use;
(c) establishing an authorization on the basis of said use rules established by the provider or receiving an authorization request transmitted by the provider, relating to said preliminary request use, for the use required for the first version of the digital object;
(d) following the establishment of the authorization or the reception of the authorization request, generating and storing in the validity repository of the use codes, a use code associated with at least one use code property and with the digital object.

3. The process according to claim 2, further comprising a transmission step of the use code to said user.

4. The process according to claim 1, further comprising:
(a) receiving a registration request as a new provider for the digital object provided by an existing provider, said registration request being transmitted by a user;
(b) transmitting to said user, information required for checking the conditions of provision and acquisition of the user rights defined by said existing provider for the digital object;
(c) defining new use rules granted by said user for the digital object and/or for obtaining said rights to use, to the extent that the new use rules are in line with the use rules of said existing provider of the digital object;
(c′) establishing an authorization based on rules defined by the existing provider or receiving an authorization request transmitted by the existing provider relating to the registration request of said user;
(d) following the establishment of an authorization on the basis of the use rules defined by the existing provider or the reception of the authorization request transmitted by the existing provider relating to the registration request, registering said user as a new provider authorized to transmit the authorization request, or to define the use rules to establish an authorization, for the use by a user of the digital object.

5. The process according to claim 1, wherein a unique identifier is associated with the first version of the digital object, the prior request including said unique identifier.

6. The process according to claim 1, wherein, prior to the provision step of the second version of the digital object, a generation step is implemented by:
(a) removing and/or modifying information of the first version in order to generate the second version;
(b) generating and storing the modified and/or removed information so as to allow the reconstitution of the information removed or modified of the first version as well as the location of the latter in the second version.

7. The process according to claim 1, wherein during the step for checking the validity of the use code, the validity of the use code is checked by ensuring that at least one validity condition of the request and/or the use code property is met, said at least one validity condition being a function of one or more parameter(s) of the following: a period of provision of the first version of the digital object, a geographical area, a number of authorization use(s) for a given use code, a language, a quality level, a type of reading terminal, a technical characteristic of the first version of the digital object, a feature of the first version of the digital object, a payment, a balance, a possibility of transmitting and/or assigning the requested right to use, a mandatory descriptive data display.

8. The process according to claim 1, wherein during the generation step of the use code, use code properties of a use code are added, taken, in particular from: a number of use authorization for a given use code, a required language, a quality level, a reading terminal type, a subset of the first version, a technical characteristic of the digital object, a feature of the digital object, a mandatory descriptive data display comprising ‘watermarking’ or copyright information.

9. The process according to claim 1, further comprising at least one tracking step comprising performing a storage of data relating to the operations of generation and use of use codes and use code properties associated and relating to each use request of a subset of the digital object.

10. The process according to claim 9, wherein the data relating to the operations of generation and use of the use codes and associated use code properties comprise, for each generated or used use code, the provider from which, was acquired this use code and, where applicable, a list of new provider(s) who have registered successively until acquiring this use code of said digital object.

11. A computer program including instructions for executing the steps of the process according to claim 1, when said program is executed by a processor.

12. A recording medium readable by a computer, on which a computer program comprising instructions for executing the steps of the process according to claim 1, is recorded.

13. A system for managing rights to use granted to users by a provider, for a first version of a digital object;
the system including at least one user terminal adapted to be coupled to a communication network, a second version of the digital object, derived from the first version, being totally of partially provided for the user terminal;
the user terminal being adapted to transmit a use request of at least one subset of the first version of the digital object, and including a use code or referring to a use code;
the system further including a facilitator module, coupled to the communication network, and adapted for:
receiving the use request;
checking the validity of the use code, with a validity repository of the use codes, and of the adequacy between the use requested for said subset of the first version of the digital object and at least one use code property associated with the use code;
in case of finding the validity of the use code, transmitting to the user terminal, information required for the reconstitution, from the second version of the digital object, of said subset of the first version, for the purpose of the requested use;
updating the at least one validity repository of the use codes and optionally the at least one of the use properties.

14. The system according to claim 13, wherein the user terminal is further adapted to transmit a registration request as a new provider of the digital object provided by an existing provider;
the facilitator module being further adapted for:
receiving the registration request as a new provider for the digital object provided by an existing provider;
transmitting to said user terminal, information required for reading the conditions of provision and acquisition of the user rights defined by said existing provider for the digital object;
defining new use rules granted by a user of the user terminal for the digital object and/or for obtaining said rights to use, to the extent that the new rights to use are in line with the use rules of said existing provider of the digital object.
establishing an authorization based on rules defined by the existing provider or receiving an authorization request transmitted by the existing provider relating to the registration request of said user terminal;
following the establishment of an authorization on the basis of the use rules defined by the existing provider or the reception of the authorization request transmitted by the existing provider relating to the registration request, registering said user as a new provider authorized to transmit the authorization request or to define the use rules to establish an authorization, for the use by a third party of the digital object.

15. The system according to claim 13, further including a controller module adapted to check the validity of the use code, while ensuring that at least one validity condition of the request and/or the use code property is filled, said at least one validity condition being a function of one or more parameters from the following list without limitation: a provision period of the first version of the digital object, a geographical area, a number of use authorization(s) for a given use code, a language, a quality level, a reading terminal type, a technical characteristic of the first version of the digital object, a feature of the first version of the digital object, a payment, a balance, a possibility of transmitting and/or assigning the requested right to use, a mandatory descriptive data display.
